(19) United States
(12) Patent Application Publication
(10) Pub. No.: US 2006/0240872 A1
(43) Pub. Date: Oct. 26, 2006

(54) ELECTRONIC DEVICE AND METHOD FOR OPERATING THE SAME

(75) Inventors: Chia-Shang Yuan, Taichung City (TW); Chih-Hao Hsin, Taipei City (TW)

Correspondence Address: Daniel R. McClure;Thomas, Kayden, Horstemeyer & Risley LLP, Suite 1750, 100 Galleria Parkway, Atlanta, GA, 30339, US

(73) Assignee: BENQ CORPORATION, Taoyuan Shien (TW)

(21) Appl. No.: 11/279,907

(22) Filed: Apr. 17, 2006

(30) Foreign Application Priority Data
Apr. 25, 2005 (TW) 94113156

(51) Int. Cl. H04B 1/38; H04M 1/00

(52) U.S. Cl. 455/564; 455/565; 455/550.1

(57) ABSTRACT

An electronic device includes an angle sensor and an input unit. The angle sensor is for detecting a rotation angle of the electronic device relative to an initial location as the electronic device rotates from the initial location. The input unit is for generating an input signal. When the rotation angle is in a first angle range, the electronic device performs a first operational command according to the input signal, and when the rotation angle is in a second angle range, the electronic device performs a second operational command according to the input signal. The method for operating the electronic device includes rotating the electronic device from an initial location to a rotation angle in a first angle range; and triggering the input unit to generate an input signal for the electronic device to perform a first operational command.

This application claims the benefit of Taiwan application Serial No. 94113156, filed Apr. 25, 2005, the subject matter of which is incorporated herein by reference

### BACKGROUND OF THE INVENTION

1. Field of the Invention

The invention relates in general to an electronic device and method for operating the same, and more particularly to an electronic device using an angle sensor and side keys to perform dialing and menu selection operations, and method for operating the same.

2. Description of the Related Art

Generally, the user performs dialing and menu selection operations by one hand as using a mobile phone under consideration of convenience. However, owing that the size of the mobile phone is increased along with the development of multi-media and personal digital assistant (PDA) function, it turns out to be very difficult for the user to complete dialing and menu selection operations by pressing all the keys with his/her thumb. Therefore, it becomes an essential subject on how to design a method for operating the mobile phone by one hand, in which each functional operation of the keyboard can be performed without the need to press every key by the thumb.

### SUMMARY OF THE INVENTION

It is therefore an object of the invention to provide an electronic device and method for operating the same. The rotation angle of the electronic device can be detected by using an embedded angle sensor, and the corresponding dialing or menu selection operation can be performed according to the predetermined angle range where the rotation angle is located and an input signal generated by side keys. Therefore, the issue a user cannot press all the keys by his/her thumb when operating the electronic device by one hand can be prevented.

The invention achieves the above-identified object by providing an electronic device including an angle sensor and an input unit. The angle sensor is for detecting a rotation angle of the electronic device relative to an initial location as the electronic device rotates from the initial location. The input unit is for generating an input signal. When the rotation angle is in a first angle range, the electronic device performs a first operational command according to the input signal, and when the rotation angle is in a second angle range, the electronic device performs a second operational command according to the input signal.

The invention achieves the above-identified object by providing a method for operating an electronic device. The method includes rotating the electronic device from an initial location to a rotation angle in a first angle range; and triggering the input unit to generate an input signal for the electronic device to perform a first operational command.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a schematic diagram of top-view and lateral-view mobile phones according to a preferred embodiment of the invention.

FIG. 1B is a schematic diagram showing the mobile phone rotating on the rotation plane parallel to the front surface of the mobile phone.

FIG. 1C is a schematic diagram showing a main menu with 3×3 square divisions on a display.

FIG. 2A is a flow chart of the method for operating the mobile phone by one hand according to the preferred embodiment of the invention.

FIG. 2B is a schematic diagram showing a usual holding gesture of a user as to holding a mobile phone.

FIG. 2C is a schematic diagram showing the available rotation angles as the user rotates the mobile phone by his/her right hand.

FIG. 2D is a schematic diagram of defining five predetermined angle ranges according to a preferred embodiment of the invention.

FIG. 2E is a schematic diagram of defining three predetermined menu-selection angle ranges according to a preferred embodiment of the invention.

FIG. 3A is a comparison table between the five predetermined dialing angle ranges and key operations corresponding to the three side keys.

FIG. 3B is a schematic diagram showing the menu selection operation of the mobile phone on a main menu with 3×3 square divisions.

FIG. 3C is a lookup table of the voltage signal values and the corresponding parameters, set in the mobile phone by firmware.

### DETAILED DESCRIPTION OF THE INVENTION

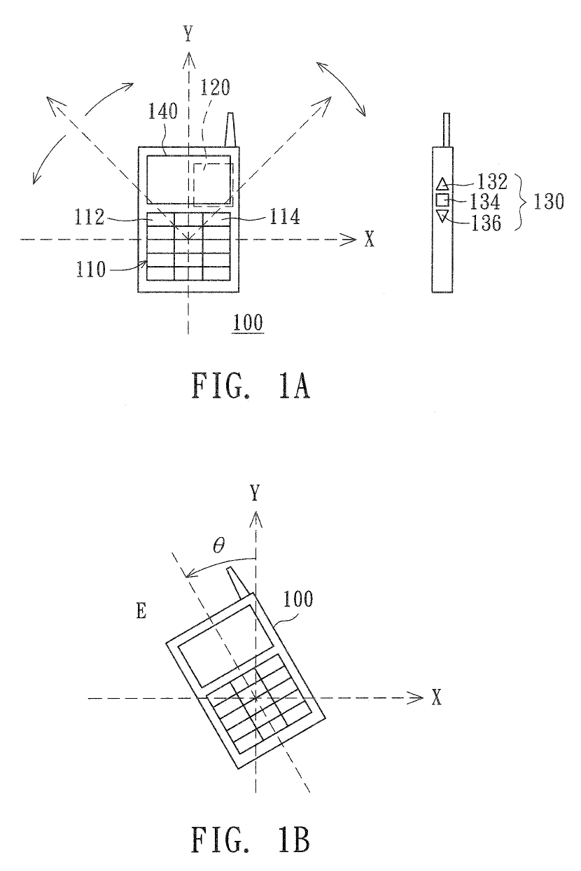

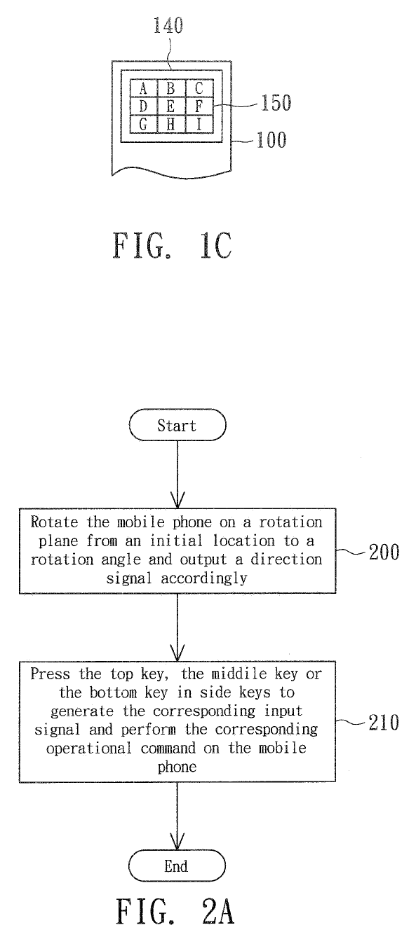

Referring to FIG. 1A, a schematic diagram of top-view and lateral-view mobile phones according to a preferred embodiment of the invention is shown. The mobile phone 100 includes a keyboard 110, an angle sensor 120, side keys 130, and a display 140. The keyboard 110, located at the front side of the mobile phone 100, includes generally a row of keys 1˜3, a row of keys 4˜6, a row of keys 7˜9, a row of keys *, 0, #, and a row of keys, the cancel key 112 and return key 114. The angle sensor 120, for example, a g-force sensor, is disposed inside the mobile phone 100 for sensing the rotation angle θ of the mobile phone 100 on the rotation plane E according to a gravitational force exerted on the mobile phone 100 as shown in FIG. 1B. The rotation plane E is parallel to the front surface of the mobile phone 100 and is formed by a vertical coordinate Y at an initial location and a horizontal coordinate X perpendicular to the Y-axis, and the rotation angle θ is calculated relative to the initial location. The angle sensor 120 outputs a direction signal, such as a voltage signal, to determine the present rotation angle θ of the mobile phone 100.

Moreover, the side keys 130 are disposed on one side of the mobile phone 100, and can be easily pressed by the thumb as the user holds the mobile phone 100. The side keys 130 include a top key 132, a middle key 134, and a bottom key 136. The mobile phone 100 can perform the corresponding operational commands according to a direction signal outputted by the angle sensor 120 and the input signal generated by pressing the side keys 130. The display 140 is disposed on the front side of the mobile phone 100 for displaying command items corresponding to the row of keys 1˜3, 4˜6, * , 0, #, or the cancel key 112 and return key 114 in accordance with the direction signal, and for displaying a main menu 150 having 3×3 square items A˜I as shown in FIG. 1C.

When the user operates the mobile phone 100 by one hand, the user rotates the mobile phone 100 so that the rotation angle θ is located in different predetermined angle ranges and then presses the side keys 130 to generate the dialing and menu selection operations corresponding to the keyboard 110. In the following, it is illustrated how to define the predetermined angle ranges and how to rotate the mobile phone and press the side keys to perform the keyboard dialing and menu selection operations.

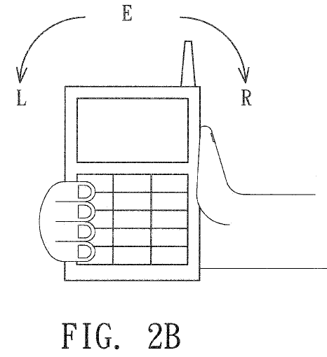

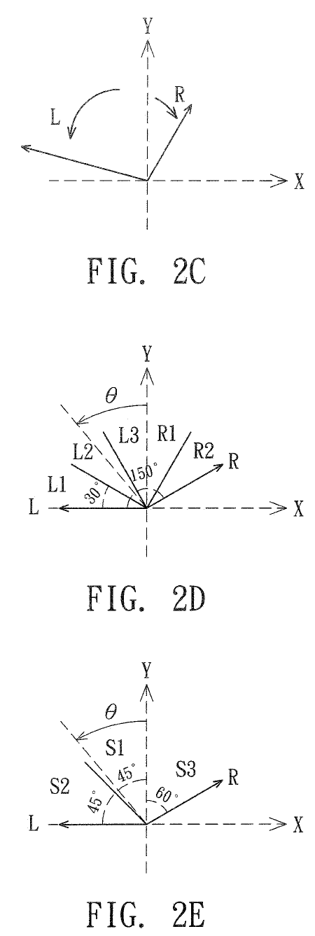

Referring to FIG. 2A, a flow chart of the method for operating the mobile phone by one hand according to the preferred embodiment of the invention is shown. First, in step 200, rotate the mobile phone 100 on the rotation plane E to have a rotation angle θ relative to the initial location, i.e. the Y axis, and to output a direction signal, such as the above-mentioned voltage signal, accordingly. Next, in step 210, press the top key 132, the middle key 134 or the bottom key 136 of the side keys 130 to generate an input signal to perform the corresponding command operation on the mobile phone 100. A dialing or menu selection operation on the mobile phone 100 can be determined as the rotation angle corresponding to the direction signal is compared with multiple adjacent predetermined angle ranges.

Generally, when the user holds a mobile phone by his/her right hand, he/she has a holding gesture as shown in FIG. 2B. Therefore, when the mobile phone 100 is tilted or rotated to the left (L) or the right (R), the available rotation range to the right will be smaller than that to the left, as shown in FIG. 2C.

In the embodiment, the available rotation range of the mobile phone 100 held by one hand is about 150 degrees and divided into 5 equal parts to respectively define five predetermined dialing angle ranges L1, L2, L3, R1 and R2, as shown in FIG. 2D. Each predetermined dialing angle range L1, L2, L3, R1, or R2 has an angle of 30 degrees, and the predetermined dialing angle ranges L3 and R1 have the Y axis to be a boundary. Moreover, the available rotation angle (about 150 degrees) of the mobile phone 100 as held by one hand is divided into three equal parts to define three predetermined menu-selection angle ranges S1, S2, and S3 as shown in FIG. 2E. The predetermined menu-selection angle ranges S1 and S2 have a radius about 45 degrees, the predetermined menu-selection angle range S3 has a radius about 60 degrees, and the predetermined menu-selection angle ranges S1 and S2 have the Y axis to be a boundary.

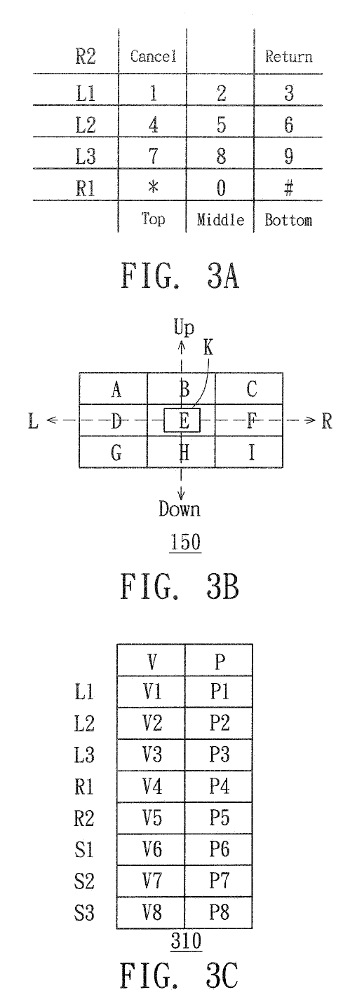

Therefore, the dialing command item or menu item corresponding to the keyboard 110 can be determined according to the predetermined angle range L1, L2, L3, R1, or R2 of FIG. 2D, or S1, S2 or S3 of FIG. 2E where the rotation angle θ of the mobile phone 100 corresponding to the direction signal is located. In terms of dialing operation, as shown in FIG. 3A, the above-mentioned dialing command items, a row of keys 1˜3, 4˜6, 7˜9, */0/#, or the cancel key 112 and return key 114, can be determined according to the predetermined dialing angle range L1, L2, L3, R1 or R2 corresponding to the direction signal. It should be noted that the predetermined angle range corresponding to the cancel key 112 and return key 114, which are used only once in a dialing process, is the one where the mobile phone 100 is most difficult to be rotated to. For example, the predetermined dialing angle range R2. Afterward, based on the selected row of keys 1˜3, 4˜6, 7˜9, */0/#, or cancel/return, the mobile phone 100 performs a dialing operation of the key in the left column (1, 4, 7, *, or cancel) according to the input signal generated by pressing the top key 132, or performs a dialing operation of the key in the middle column (2, 5, 8, or 0) according to the input signal generated by pressing the middle key 134, or performs a dialing operation of the key in the right column (3, 6, 9, #, or return) according to the input signal generated by pressing the bottom key 136.

In terms of menu selection operation, as shown in FIG. 3B, the mobile phone 100 determines the rotation angle θ according to the direction signal and performs a menu-item operation such as cursor (K) moving left (L), exiting the main menu 150, and cursor (K) moving right (R) by comparing the rotation angle θ with the predetermined menu-selection angle ranges S1˜S3.

Next, based on the above-mentioned menu 150, the mobile phone 100 performs a cursor moving-up (UP) operation according to the input signal generated by pressing the top key 132, or performs a cursor moving-down (Down) operation according to the input signal generated by pressing the bottom key 136, or selects the item the cursor defines in the main menu 300, or exits the main menu 300 according to the input signal generated by pressing the middle key 134.

As described above, the dialing command items or menu items can be displayed on the display 140 for the user to select the required dialing command operation or menu item operation. The mobile phone 100 detects the rotation angle θ by the angle sensor 120 and accordingly outputs a voltage signal. The mobile phone 100 sets a parameter lookup table 310 in firmware as shown in FIG. 3C. The parameter lookup table 310 includes a column of voltage ranges V and a column of control parameters P. The voltage ranges V1˜V8 are respectively corresponding to the predetermined angle ranges L1˜L3, R1˜R2, and S1˜S3. When performing a dialing operation, the mobile phone 100 obtains the corresponding control parameter P1, . . . , or P5 via the parameter lookup table 310 according to the voltage ranges V1, . . . , or V5 where the voltage signal value is located, so as to determine a row of key items and then performs the corresponding key dialing operation according to the input signal generated by pressing the side keys 130. When performing the menu selection operation, the mobile phone 100 obtains the corresponding control parameter P6, . . . , or P8 via the parameter lookup table 310 according to the voltage range V6, . . . , or V8 where the voltage signal value is located, and then performs an operation of cursor moving-left, cursor moving-right, cursor moving-up, cursor moving down, selecting one item, or exiting the menu according to the input signal generated by pressing the side keys 130.

As illustrated above, although holding the mobile phone by right hand is taken as an example in the invention, the method of the invention can also be applied to the user holding the mobile phone by his/her left hand, and the rotation plane can also be vertical to the front surface of the mobile phone. Each predetermined angle range can also have a different range and the dialing and menu selection operations corresponding to each predetermined angle range can also be set according to the convenience and intuition of the user holding the mobile phone. Furthermore, a required number of predetermined angle ranges and side keys can be set according to the number of the keys in a keyboard of the mobile phone. As long as the multiple predetermined angle ranges defined on the rotation plane and the side key can be used to achieve the corresponding keyboard function operations, all these will not be apart from the scope of the invention.

Besides, although the mobile phone having side keys is taken as an example in the invention, the invention can also be applied to any electronic device having an angle sensor and an input unit. As long as the direction signal generated by the angle sensor can be used to obtain the rotation angle of the mobile phone and the required dialing command operation or menu item operation can be determined according to the predetermined dialing or menu selection angle range where the rotation angle is located and the input signal generated by the input unit, it will not depart from the scope of the invention.

According to the above-mentioned preferred embodiment, the electronic device and method for operating the same has the following advantages:

1. The dialing command or menu selection operations can be easily performed on the electronic device by using an angle sensor and an input unit (for example side keys) disposed in the electronic device. Therefore, the issue that users cannot operate the large-scale electronic device by one hand can be solved.

2. Owing that the operational method of the invention is defined according to ergonomics, the method is intuitive and easily understood, and the software of the electronic device can have high accuracy in determining the rotation angles.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device, comprising:
an angle sensor, for detecting a rotation angle of the electronic device relative to an initial location as the electronic device rotates from the initial location; and
an input unit, for generating an input signal, wherein when the rotation angle is in a first angle range, the electronic device performs a first operational command according to the input signal, and when the rotation angle is in a second angle range, the electronic device performs a second operational command according to the input signal.

2. The electronic device according to claim 1, wherein the electronic device rotates on a rotation plane, and the first angle range and the second angle range are adjacent to each other.

3. The electronic device according to claim 2, wherein the electronic device further comprises a display, and the first operational command and the second operational command are selectively displayed on the display according to the rotation angle.

4. The electronic device according to claim 1, wherein the angle sensor detects the rotation angle according to a gravitational force exerted on the electronic device.

5. The electronic device according to claim 1, having an upper surface and a side-surface adjacent to the upper surface, wherein the electronic device further comprises a display disposed on the upper surface, and the input unit is disposed on the side surface.

6. The electronic device according to claim 5 wherein the input unit has three input buttons and the display displays nine operational commands by a 3×3 menu, and when the rotation angle is in one of the three angle ranges, the three input buttons are respectively corresponding to three commands of a column or a row of items in the 3×3 menu.

7. The electronic device according to claim 5, the input unit comprising three input buttons and the display displaying nine operational commands by a 3×3 menu and a cursor, wherein three angle ranges of the rotation angle respectively correspond to 3×3 menu operations of cursor moving left, cursor moving right, and exiting the menu and the three input buttons respectively correspond to 3×3 menu operations of cursor moving up, cursor moving down, and selecting one of the nine operational commands at the cursor.

8. The electronic device according to claim 5, wherein the electronic device is a mobile communication device, the mobile communication device comprises a keyboard having a plurality of input keys, the keyboard is disposed on the upper surface, and the input unit is used to select operational functions of a set of the input keys corresponding to the rotation angle and the display displays the set of the input keys.

9. A method for operating an electronic device, the electronic device comprising an input unit, the method comprising:
rotating the electronic device from an initial location to a rotation angle in a first angle range; and
triggering the input unit to generate an input signal for the electronic device to perform a first operational command.

10. The method according to claim 9, further comprising rotating the electronic device to an rotation angle in a second angle range adjacent to the first angle range, and triggering the input unit to generate the input signal for the electronic device to perform a second operational command.

11. The method according to claim 10, further comprising selectively displaying the first operational command and the second operational command on a display according to the rotation angle.

12. The method according to claim 9, wherein the input unit has three input buttons and the electronic device has a display for displaying nine operational commands by a 3×3 menu, the method further comprising:
rotating the electronic device to one of three different angle ranges; and
triggering one of the three input buttons to perform one of three commands corresponding to a column or a row of items in the 3×3 menu on the electronic device.

13. The method according to claim 9, wherein the input unit has three input buttons and the electronic device has a display for displaying nine operational commands by a 3×3 menu and a cursor, the method further comprising:
rotating the electronic device to have the rotation angle in one of three different angle ranges and to perform corresponding 3×3 menu operations of cursor moving left, cursor moving right, and exiting the menu; and
triggering one of the three input buttons to perform corresponding 3×3 menu operations of cursor moving up, cursor moving down, and selecting one of the nine operational commands at the cursor.

14. The method according to claim 9, wherein the electronic device is a mobile communication device comprising a 5×3 keyboard and the input unit includes three input buttons, the method further comprising:
rotating the electronic device to have the rotation angle in one of five different angle ranges; and
triggering one of the three input buttons to perform an operation corresponding to one of three input keys in a key-row of the 5×3 keyboard.

15. The method according to claim 14, further comprising displaying dialing command items corresponding to the 5×3 keyboard on a display.
